(19) United States
(12) Patent Application Publication
(10) Pub. No.: US 2007/0238436 A1
(43) Pub. Date: Oct. 11, 2007

(54) Radio reception apparatus receiving multiple radio signals different in frequency

(75) Inventor: Kohji Motoyama, Osaka-shi (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/727,445

(22) Filed: Mar. 27, 2007

(30) Foreign Application Priority Data
Apr. 11, 2006 (JP) 2006-108754 (P)

(51) Int. Cl. H04B 1/26

(52) U.S. Cl. 455/313

(57) ABSTRACT

A radio reception apparatus includes a reception portion receiving a radio signal, a local oscillation circuit outputting a first local oscillation signal, a local oscillation circuit outputting a second local oscillation signal, a mixer frequency-converting the received radio signal by multiplying the received radio signal by the first local oscillation signal and outputting the frequency-converted signal, a distribution circuit distributing the output signal of the mixer, and a mixer frequency-converting the output signal of the RF mixer by multiplying any one of the signals distributed by the distribution circuit by the second local oscillation signal and outputting the frequency-converted signal.

This nonprovisional application is based on Japanese Patent Application No. 2006-108754 filed with the Japan Patent Office on Apr. 11, 2006, the entire contents of which are hereby incorporated by reference.

### FIELD OF THE INVENTION

The present invention relates to a radio reception apparatus, and more particularly to a radio reception apparatus receiving a plurality of radio signals different in frequency.

### DESCRIPTION OF THE BACKGROUND ART

An LNB (Low Noise Block Down Converter) attached to an antenna for receiving satellite broadcasting represents a type of a radio reception apparatus. The LNB receives a weak radio wave in a 12 GHz band from a satellite, frequency-converts the received weak radio wave to an intermediate frequency (IF) in a 1 GHz band, low-noise amplifies the frequency-converted signal, and outputs a low-noise signal having sufficient level to a DBS (Direct Broadcast Satellite) tuner. The DBS tuner processes the signal received from the LNB via a coaxial cable by using an internal circuit, and outputs the processed signal to a television receiver.

As an example of a radio reception apparatus, Japanese Patent Laying-Open No. 03-208417 (Patent Document 1) discloses an input signal stabilization circuit for an IC tuner (radio reception apparatus) as follows. Specifically, the IC tuner including an RF amplifier, a local oscillator, a mixer, a band-pass filter, and an IF amplifier includes band-pass filter means for configuring a variable tuning circuit, or configured in a preceding stage of the IC tuner for each reception signal band, and low-noise amplifier means for receiving signals from the band-pass filter and an automatic gain adjuster and controlling automatic gain in correspondence with strong/weak reception signals as a control signal in a wide band.

In addition, Japanese Patent Laying-Open No. 08-293812 (Patent Document 2) discloses a switching circuit for a converter for satellite broadcasting (radio reception apparatus) as follows. Specifically, the switching circuit for the converter for satellite broadcasting, that switches between a plurality of local oscillators having different oscillation frequencies and contained in the converter for satellite broadcasting in response to a pulse signal superimposed with a band-switching pulse signal emitted from a satellite broadcast tuner, includes: a filter circuit taking in the pulse signal from the satellite broadcasting tuner and extracting only a frequency component of the band-switching pulse signal; an amplifier circuit amplifying the pulse signal from the filter circuit; a rectifier circuit rectifying the pulse signal amplified by the amplifier circuit; a comparison circuit comparing a DC voltage from the rectifier circuit with a reference voltage and outputting a signal indicating whether the band-switching pulse signal is superimposed on the pulse signal; and a drive circuit receiving the signal from the comparison circuit and driving the local oscillator having the oscillation frequency in accordance with a result of comparison.

A satellite transmits RF (Radio Frequency) signals, that is, radio signals, corresponding to a plurality of bands different in frequency. Accordingly, a radio reception apparatus capable of receiving a plurality of RF signals transmitted from the satellite is demanded.

The radio reception apparatus according to Patent Document 1, however, is not configured to receive a plurality of RF signals, although it is configured to frequency-convert the received RF signal and generate an IF signal. Here, in general, the circuit for receiving the RF signal is high in a degree of design difficulty and expensive in terms of cost of parts. Therefore, if a plurality of radio reception apparatuses according to Patent Document 1 are simply combined to configure the radio reception apparatus receiving a plurality of RF signals, a plurality of circuits for receiving the RF signals should be provided, and cost for design and parts of the radio reception apparatus become expensive.

Meanwhile, in the radio reception apparatus according to Patent Document 2, a plurality of local oscillation circuits for a high-frequency signal and peripheral circuits thereof for frequency-conversion of RF signals to IF signals, in the number corresponding to the number of RF signals, are required, and cost for design and parts of the radio reception apparatus become expensive.

### SUMMARY OF THE INVENTION

An object of the present invention is to provide a radio reception apparatus capable of receiving a plurality of radio signals and avoiding increase in production cost.

A radio reception apparatus according to one aspect of the present invention includes: a reception portion receiving a radio signal; a first local oscillation circuit outputting a first local oscillation signal; a second local oscillation circuit outputting a second local oscillation signal; an RF mixer frequency-converting received radio signal by multiplying the received radio signal by the first local oscillation signal and outputting the frequency-converted signal; a first distribution circuit distributing the output signal of the RF mixer; and an IF mixer frequency-converting the output signal of the RF mixer by multiplying any one of the signals distributed by the first distribution circuit by the second local oscillation signal and outputting the frequency-converted signal.

Preferably, the radio reception apparatus further includes a selection circuit selecting any one of the signals distributed by the first distribution circuit and the output signal of the IF mixer, and outputting the selected signal.

Preferably, the radio reception apparatus further includes: a second distribution circuit distributing the signal distributed by the first distribution circuit; a third distribution circuit distributing the output signal of the IF mixer; and a plurality of selection circuits each receiving the signal distributed by the second distribution circuit and the signal distributed by the third distribution circuit, selecting any one of the received distributed signals, and outputting the selected signal.

Preferably, the radio reception apparatus further includes a first filter circuit attenuating a prescribed frequency component contained in the signal distributed by the first distribution circuit, and a second filter circuit attenuating a prescribed frequency component contained in the output signal of the IF mixer.

Preferably, the first filter circuit and the second filter circuit are formed with an element or a pattern.

Preferably, the radio reception apparatus receives a plurality of radio signals different in polarization and includes a plurality of reception portions, a plurality of RF mixers, a plurality of first distribution circuits, and a plurality of IF mixers, in correspondence with the radio signals.

Preferably, the radio reception apparatus further includes a selection circuit selecting any one of the signals distributed by the plurality of first distribution circuits and the output signals of the plurality of IF mixers, and outputting the selected signal.

According to the radio reception apparatus of the present invention, a plurality of radio signals can be received and increase in production cost can be avoided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of a satellite broadcasting reception system according to a first embodiment of the present invention.

FIG. 2 is a functional block diagram showing an exemplary configuration of an LNB.

FIGS. 3 and 4 are functional block diagrams showing exemplary universal LNBs.

FIG. 5 is a functional block diagram showing a configuration of a radio reception apparatus according to the first embodiment of the present invention.

FIG. 6 illustrates an operation performed by the universal LNB shown in FIG. 3 or 4, for frequency-conversion of an RF signal to an IF signal.

FIG. 7 illustrates an operation performed by the radio reception apparatus according to the first embodiment of the present invention, for frequency-conversion of an RF signal to an IF signal.

FIG. 8 is a functional block diagram showing a configuration of a radio reception apparatus according to a variation of the first embodiment of the present invention.

FIG. 9A is a circuit diagram showing in detail a configuration of a filter F11.

FIG. 9B is a circuit diagram showing in detail a configuration of a filter F12.

FIG. 9C is a circuit diagram showing in detail a configuration of a filter F21.

FIGS. 10A and 10B illustrate a coil formed with a pattern.

FIG. 11 is a functional block diagram showing a configuration of a radio reception apparatus according to a second embodiment of the present invention.

FIG. 12 is a functional block diagram showing a configuration of a switching circuit in the radio reception apparatus according to the second embodiment of the present invention.

FIG. 13 is a functional block diagram showing a configuration of a radio reception apparatus according to a variation of the second embodiment of the present invention.

FIGS. 14 and 15 are functional block diagrams showing exemplary configurations of a universal twin LNB.

FIG. 16 is a functional block diagram showing a configuration of a radio reception apparatus according to a third embodiment of the present invention.

FIGS. 17 to 19 are functional block diagrams showing configurations of a radio reception apparatus according to variations of the third embodiment of the present invention.

FIG. 20 is a functional block diagram showing a configuration of a switching circuit in the radio reception apparatus according to the third embodiment of the present invention.

### DESCRIPTION OF THE PREFERRED EMBODIMENTS

An embodiment of the present invention will be described hereinafter with reference to the drawings. The same or corresponding elements in the drawings have the same reference characters allotted, and description thereof will not be repeated.

### First Embodiment

[Configuration]

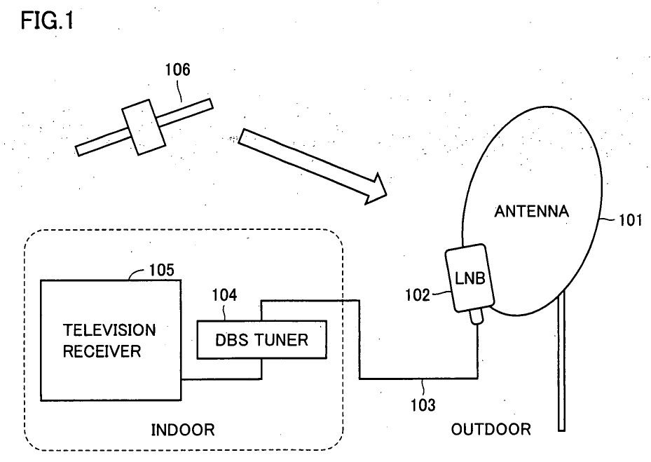

FIG. 1 is a diagram showing a configuration of a satellite broadcasting reception system according to a first embodiment of the present invention.

Referring to FIG. 1, the satellite broadcasting reception system includes an antenna 101, an LNB (radio reception apparatus) 102, a BS-IF cable 103, a DBS tuner 104, and a television receiver 105.

Antenna 101 receives, as a radio signal, a weak radio wave having a frequency band, for example from 11.71 GHz to 12.01 GHz, from a broadcast satellite 106.

LNB 102 is attached to antenna 101, frequency-converts the radio signal received by antenna 101 to an IF signal having a frequency band, for example from 1035 MHz to 1335 MHz, low-noise amplifies the IF signal, and outputs the low-noise amplified IF signal to DBS tuner 104 through BS-IF cable 103.

DBS tuner 104 processes the IF signal received from LNB 102 in an internal circuit, and outputs the processed signal to television receiver 105.

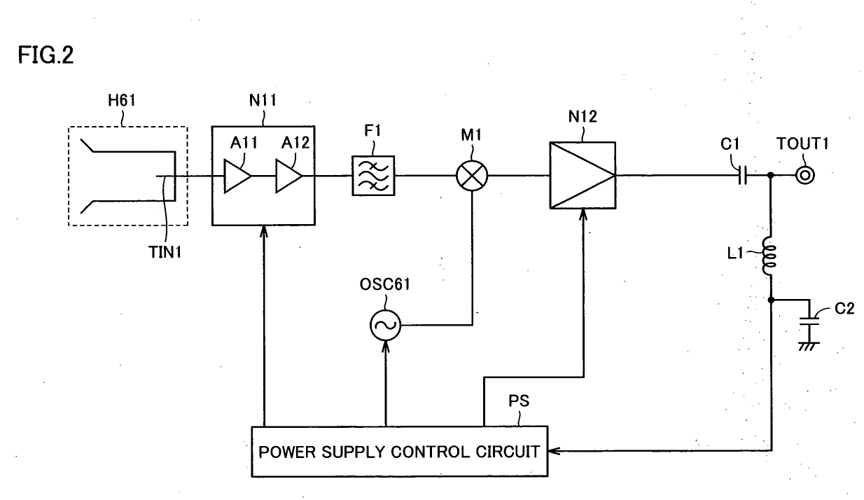

FIG. 2 is a functional block diagram showing an exemplary configuration of the LNB.

Referring to FIG. 2, the LNB includes a horn portion H61, a low-noise amplifier portion N11, a band-pass filter F1, a mixer M1, a local oscillation circuit OSC61, an IF amplifier portion N12, a coil L1, capacitors C1 and C2, an output terminal TOUT1, and a power supply control circuit PS.

Horn portion H61 includes, for example, an input terminal (reception portion) TIN1 implemented as an antenna probe in a waveguide. Low-noise amplifier portion N11 includes low-noise amplifiers A11 and A12 connected in series.

Horn portion H61 receives the radio signal transmitted from broadcast satellite 106 at input terminal TIN1, and outputs the signal to low-noise amplifier portion N11. The radio signal transmitted from broadcast satellite 106 is a radio signal having a frequency band, for example from 111.71 GHz to 12.01 GHz.

Low-noise amplifier portion N11 low-noise amplifies the radio signal received from horn portion H61 through input terminal TIN1, and outputs the low-noise amplified signal to band-pass filter F1.

Band-pass filter F1 attenuates a frequency component outside a prescribed frequency band, for example an image signal, in the signal received from low-noise amplifier portion N11.

Local oscillation circuit OSC61 outputs a local oscillation signal, for example, at a frequency of 10.678 GHz.

Mixer M1 multiples a signal that has passed through band-pass filter F1 by the local oscillation signal received from local oscillation circuit OSC61, so as to frequency-convert the signal that has passed through band-pass filter F1 to an IF signal.

IF amplifier portion N12 low-noise amplifies the IF signal received from mixer M1, and outputs the low-noise amplified signal from output terminal TOUT1 to the outside. From output terminal TOUT1, an IF signal having a frequency band, for example from 1035 MHz to 1335 MHz, is output.

Capacitor C1 permits passage of only an AC component in the IF signal received from IF amplifier portion N12. Therefore, the AC component in the IF signal is output from output terminal TOUT1 to the outside.

Electric power is supplied to power supply control circuit PS from an external apparatus such as DBS tuner 104 through output terminal TOUT1.

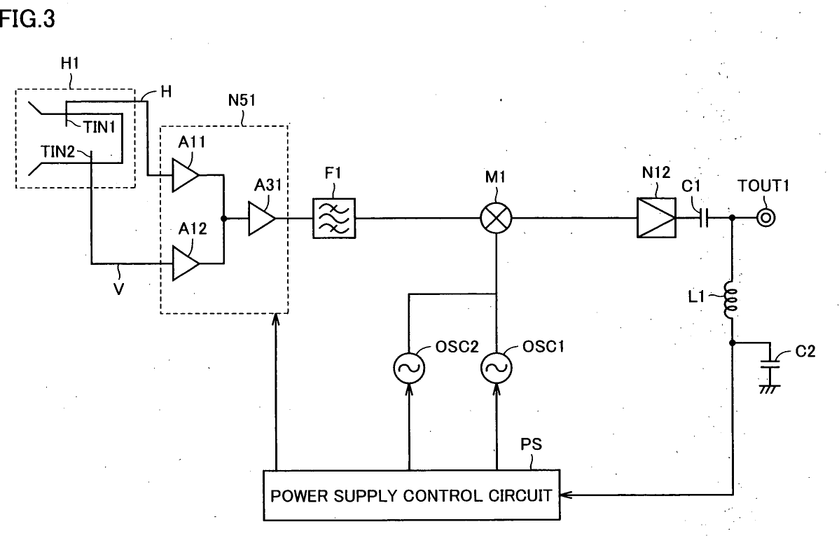

FIG. 3 is a functional block diagram showing an exemplary universal LNB.

Referring to FIG. 3, the universal LNB includes a horn portion H1, a low-noise amplifier portion N51, band-pass filter F1, mixer M1, local oscillation circuits OSC1 and OSC2, IF amplifier portion N12, coil L1, capacitors C1 and C2, output terminal TOUT1, and power supply control circuit PS.

Horn portion H1 includes, for example, input terminals (reception portions) TIN1 and TIN2 implemented as antenna probes in a waveguide. Low-noise amplifier portion N51 includes low-noise amplifiers A11, A12 and A31.

Horn portion H1 receives the radio signal transmitted from broadcast satellite 106. The radio signal transmitted from broadcast satellite 106 includes, for example, a radio signal (frequency component) having a frequency band in low band, that is, from 10.7 GHz to 11.7 GHz, and a radio signal (frequency component) having a frequency band in high band, that is, from 11.7 GHz to 12.75 GHz.

In addition, in the radio signal output from broadcast satellite 106, two types of polarizations, that is, V polarization (vertical polarization) and H polarization (horizontal polarization), are present. Accordingly, horn portion H1 has two input terminals for receiving radio signals of both types of polarizations, and outputs the radio signals of both types of polarizations received at respective terminals to respective low-noise amplifiers.

Namely, horn portion H1 receives the radio signal of H polarization output from broadcast satellite 106 at input terminal TIN1, and outputs the signal to low-noise amplifier A11. In addition, horn portion H1 receives the radio signal of V polarization output from broadcast satellite 106 at input terminal TIN2, and outputs the signal to low-noise amplifier A12.

Low-noise amplifier portion N51 low-noise amplifies the radio signal of H polarization received from horn portion H1 through input terminal TIN1 in low-noise amplifiers A11 and A31, and outputs the amplified signal to band-pass filter F1.

Low-noise amplifier portion N51 low-noise amplifies the radio signal of V polarization received from horn portion H1 through input terminal TIN2 in low-noise amplifiers A12 and A31, and outputs the amplified signal to band-pass filter F1.

Band-pass filter F1 attenuates a frequency component outside a prescribed frequency band in the signal received from low-noise amplifier portion N51.

Low-noise amplifiers A11, A12 and A31 start amplification and output of the signal when electric power is supplied, and stop amplification and output of the signal when electric power is not supplied.

Power supply control circuit PS selects any one of low-noise amplifiers A11 and A12 and supplies the selected one with a bias voltage, that is, electric power, so that any one of the radio signal of H polarization and the radio signal of V polarization is selected and output to low-noise amplifier A31.

Local oscillation circuit OSC1 outputs, for example, a local oscillation signal having a frequency of 9.75 GHz that corresponds to the radio signal in low band. Local oscillation circuit OSC2 outputs, for example, a local oscillation signal having a frequency of 10.6 GHz that corresponds to the radio signal in high band. Local oscillation circuits OSC1 and OSC2 start oscillation when electric power is supplied and stop oscillation when electric power is not supplied.

Power supply control circuit PS selects any one of local oscillation circuits OSC1 and OSC2 and supplies the selected one with electric power, so that any one of the local oscillation signal generated by local oscillation circuit OSC1 and the local oscillation signal generated by local oscillation circuit OSC2 is selected and output to mixer M1.

As the configuration and the operation are otherwise the same as in the LNB shown in FIG. 2, detailed description will not be repeated here.

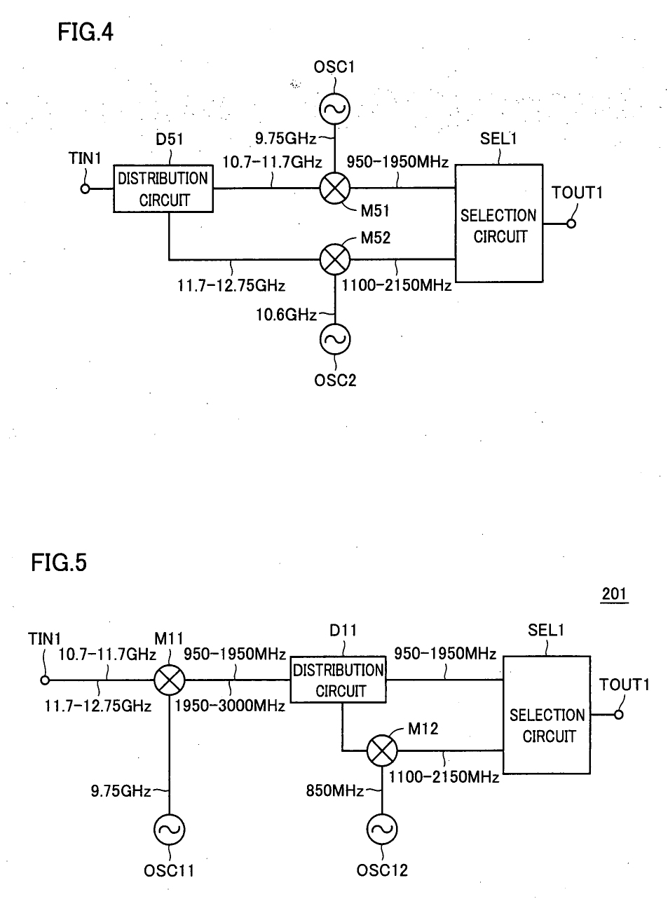

FIG. 4 is a functional block diagram showing an exemplary universal LNB.

Referring to FIG. 4, the universal LNB includes input terminal (reception portion) TIN1, mixers M51 and M52, a distribution circuit D51, local oscillation circuits OSC1 and OSC2, a selection circuit SEL1, and output terminal TOUT1.

Distribution circuit D51 distributes the radio signal received at input terminal TIN1 to mixer M51 and mixer M52.

Mixer M51 multiplies the radio signal received from distribution circuit D51 by the local oscillation signal received from local oscillation circuit OSC1, so as to frequency-convert the radio signal to the IF signal. For example, if the universal LNB receives the radio signal in low band, the IF signal output from mixer M51 has a frequency band from 950 MHz to 1950 MHz.

Mixer M52 multiplies the radio signal received from distribution circuit D51 by the local oscillation signal received from local oscillation circuit OSC2, so as to frequency-convert the radio signal to the IF signal. For example, if the universal LNB receives the radio signal in high band, the IF signal output from mixer M52 has a frequency band from 1100 MHz to 2150 MHz.

Selection circuit SEL1 selects any one of the output signal of mixer M51 and the output signal of mixer M52, and outputs the selected signal from output terminal TOUT1 to the outside. For example, when the universal LNB receives the radio signal in low band, selection circuit SEL1 selects the IF signal received from mixer M51 and having a frequency band from 950 MHz to 1950 MHz and outputs that signal. In addition, when the universal LNB receives the radio signal in high band, selection circuit SEL1 selects the IF signal received from mixer M52 and having a frequency band from 1100 MHz to 2150 MHz and outputs that signal.

As the configuration and the operation are otherwise the same as in the universal LNB shown in FIG. 3, detailed description will not be repeated here.

Here, the universal LNB shown in FIGS. 3 and 4 should include two RF circuits constituted of mixers, local oscillation circuits, and the like, in correspondence with the radio signal of high band and the radio signal of low band, and cost for design and parts of the radio reception apparatus become expensive.

The radio reception apparatus according to the first embodiment of the present invention solves such a problem of the universal LNB shown in FIGS. 3 and 4.

FIG. 5 is a functional block diagram showing a configuration of the radio reception apparatus according to the first embodiment of the present invention.

Referring to FIG. 5, a radio reception apparatus 201 includes input terminal (reception portion) TIN1, a mixer (RF mixer) M11, a mixer (IF mixer) M12, a distribution circuit (first distribution circuit) D11, local oscillation circuits OSC11 and OSC12, selection circuit SEL1, and output terminal TOUT1.

Local oscillation circuit OSC11 outputs a local oscillation signal, for example, at a frequency of 9.75 GHz. Local oscillation circuit OSC12 outputs a local oscillation signal, for example, at a frequency of 850 MHz.

Mixer M11 multiplies the radio signal received at input terminal TIN1 by the local oscillation signal received from local oscillation circuit OSC11, so as to frequency-convert the radio signal to the first IF signal. For example, if radio reception apparatus 201 receives the radio signal in low band, the first IF signal has a frequency band from 950 MHz to 1950 MHz. In addition, if radio reception apparatus 201 receives the radio signal in high band, the first IF signal has a frequency band from 1950 MHz to 3000 MHz.

Distribution circuit D11 distributes the first IF signal received from mixer M11 to selection circuit SEL1 and mixer M12.

Mixer M12 multiplies the first IF signal received from distribution circuit D11 by the local oscillation signal received from local oscillation circuit OSC12, so as to frequency-convert the first IF signal to the second IF signal. For example, if radio reception apparatus 201 receives the radio signal in high band, the second IF signal has a frequency band from 1100 MHz to 2150 MHz.

Selection circuit SEL1 selects any one of the first IF signal and the second IF signal, and outputs the selected signal from output terminal TOUT1 to the outside. For example, when radio reception apparatus 201 receives the radio signal in low band, selection circuit SEL1 selects the first IF signal received from distribution circuit D11 and having a frequency band from 950 MHz to 1950 MHz and outputs that signal. In addition, when radio reception apparatus 201 receives the radio signal in high band, selection circuit SEL1 selects the second IF signal received from mixer M12 and having a frequency band from 1100 MHz to 2150 MHz and outputs that signal.

It is noted that radio reception apparatus 201 may be configured such that selection circuit SEL1 is not provided and the first IF signal and the second IF signal are output from output terminal TOUT1 to the outside. Alternatively, radio reception apparatus 201 may be configured such that power supply control circuit PS is provided instead of selection circuit SEL1 and switching between power supply to local oscillation circuit OSC11 and power supply to local oscillation circuit OSC12 is made, whereby any one of the first IF signal and the second IF signal is selected and output to the outside.

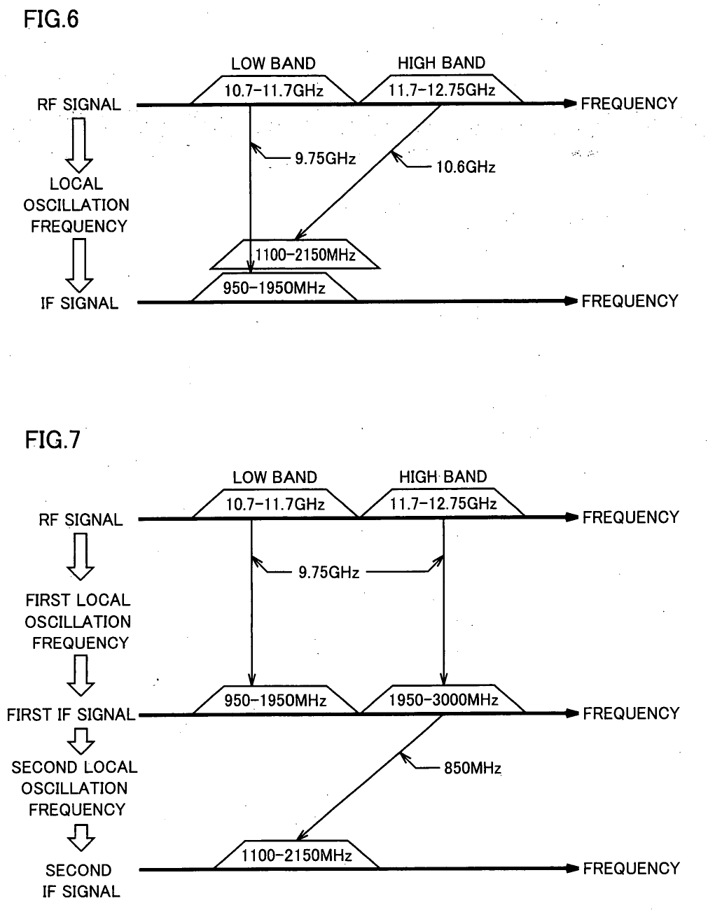

FIG. 6 illustrates an operation performed by the universal LNB shown in FIG. 3 or 4, for frequency-conversion of an RF signal to an IF signal.

Referring to FIG. 6, the universal LNB shown in FIG. 3 or 4 uses the local oscillation signal at a frequency of 9.75 GHz to frequency-convert the RF signal having a frequency band in low band from 10.7 GHz to 11.7 GHz to the first IF signal having a frequency band from 950 MHz to 1950 MHz. In addition, the universal LNB shown in FIG. 3 or 4 uses the local oscillation signal at a frequency of 10.6 GHz to frequency-convert the RF signal having a frequency band in high band from 11.7 GHz to 12.75 GHz to the second IF signal having a frequency band from 1100 MHz to 2150 MHz.

FIG. 7 illustrate an operation performed by the radio reception apparatus according to the first embodiment of the present invention, for frequency-conversion of an RF signal to an IF signal.

Referring to FIG. 7, radio reception apparatus 201 uses the local oscillation signal at a frequency of 9.75 GHz to frequency-convert the RF signal to the first IF signal, whether it receives either of the RF signal in low band or the RF signal in high band. If radio reception apparatus 201 receives the RF signal in high band, radio reception apparatus 201 further uses the local oscillation signal at a frequency of 850 MHz to frequency-convert the first IF signal having a frequency band from 1950 MHz to 3000 MHz to the second IF signal having a frequency band from 1100 MHz to 2150 MHz. If radio reception apparatus 201 receives the RF signal in low band, radio reception apparatus 201 outputs the first IF signal to the outside, and if radio reception apparatus 201 receives the RF signal in high band, radio reception apparatus 201 outputs the second IF signal to the outside.

In the radio reception apparatuses described in Patent Document 1 and Patent Document 2 and in the universal LNBs shown in FIGS. 3 and 4, circuits for receiving the RF signals in the number corresponding to the number of RF signals have been required, and the cost for design and parts of the radio reception apparatus are disadvantageously high. In the radio reception apparatus according to the first embodiment of the present invention, however, mixer M11 multiplies the radio signal received at input terminal TIN1 by the local oscillation signal received from local oscillation circuit OSC11, thereby frequency-converting the radio signal to the first IF signal. Distribution circuit D11 distributes the first IF signal received from mixer M11 to selection circuit SEL1 and mixer M12. Then, mixer M12 multiplies the first IF signal received from distribution circuit D11 by the local oscillation signal received from local oscillation circuit OSC12, thereby frequency-converting the first IF signal to the second IF signal. According to such a configuration, simply by providing mixer M11 and local oscillation circuit OSC11 as the circuits for receiving the RF signals, the IF signals corresponding to respective RF signals in low band and high band can be generated as in the universal LNBs shown in FIGS. 3 and 4. Namely, in the radio reception apparatus according to the first embodiment of the present invention, circuits for receiving the RF signals in the number corresponding to the number of RF signals are no longer required, and expensive cost for design and parts can be avoided.

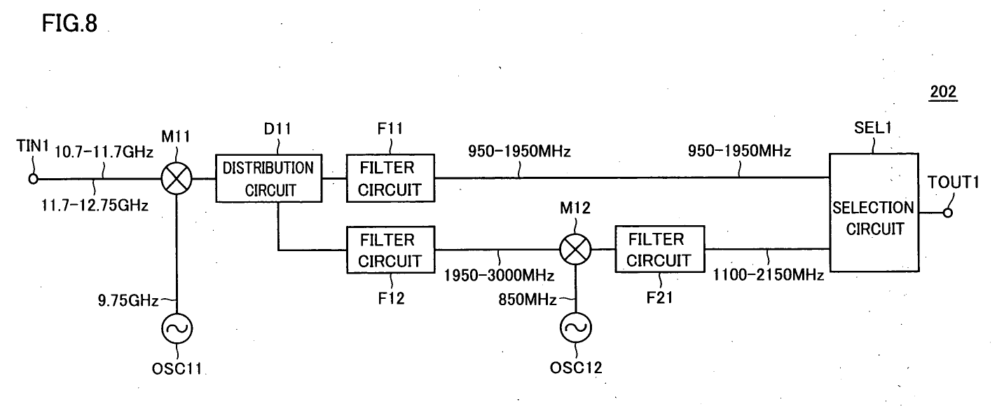

FIG. 8 is a functional block diagram showing a configuration of a radio reception apparatus according to a variation of the first embodiment of the present invention.

Referring to FIG. 8, a radio reception apparatus 202 is different from radio reception apparatus 201 in further including filter circuits F11, F12 and F21.

Distribution circuit D11 distributes the first IF signal received from mixer M11 to filter circuits F11 and F12.

Filter circuits F11 and F12 attenuate the frequency component outside a prescribed frequency band in the first IF signals received from mixer M11.

Mixer M12 multiplies the first IF signal that has passed through filter circuit F12 by the local oscillation signal received from local oscillation circuit OSC12, so as to frequency-convert the first IF signal to the second IF signal.

Filter circuit F21 attenuates the frequency component outside a prescribed frequency band in the second IF signal received from mixer M12.

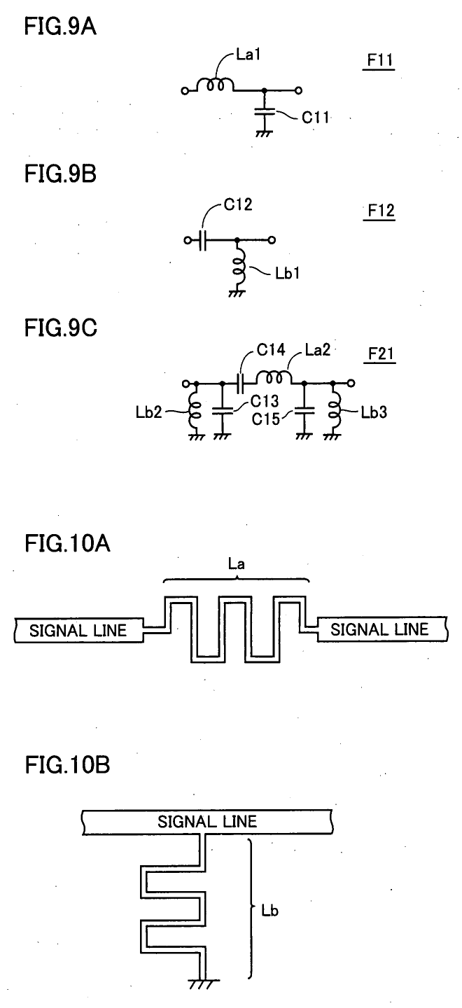

FIG. 9A is a circuit diagram showing in detail a configuration of filter F11. FIG. 9B is a circuit diagram showing in detail a configuration of filter F12. FIG. 9C is a circuit diagram showing in detail a configuration of filter F21.

Referring to FIG. 9A, filter F11 is implemented, for example, as a low-pass filter. More specifically, filter F11 includes a coil La1 and a capacitor C11. Coil La1 has one end connected to one end of capacitor C11. Capacitor C11 has the other end connected to a ground potential.

Referring to FIG. 9B, filter F12 is implemented, for example, as a high-pass filter. More specifically, filter F12 includes a coil Lb1 and a capacitor C12. Capacitor 12 has one end connected to one end of coil Lb1. Coil Lb1 has the other end connected to a ground potential.

Referring to FIG. 9C, filter F21 is implemented, for example, as a band-pass filter. More specifically, filter F21 includes a coil La2, coils Lb2 and Lb3, and capacitors C13 to C15. Coil Lb2 has one end connected to one end of capacitor C13 and to one end of capacitor C14. Capacitor C14 has the other end connected to one end of coil La2. Coil Lb3 has one end connected to one end of capacitor C15 and to the other end of coil La2. The other end of coil Lb2, the other end of coil Lb3, the other end of capacitor C13, and the other end of capacitor C15 are connected to a ground potential.

It is noted that each of filters F11, F12 and F21 may be configured such that a plurality of circuits shown in FIGS. 9A to 9C are connected in series.

In addition, the configurations of filters F11, F12 and F21 are not limited to those as including a coil element and a capacitor element as shown in FIGS. 9A to 9C, and for example, the filters may be implemented by a dielectric filter element. By using a dielectric filter element, variation in the filter characteristics can be lowered.

FIGS. 10A and 10B illustrate a coil formed with a pattern.

Referring to FIG. 10A, a coil La corresponds to coils La1 and La2 shown in FIGS. 9A to 9C. Coil La is formed, for example, on a signal line of a 50Ω type.

Referring to FIG. 10B, a coil Lb corresponds to coils Lb1 to Lb3 shown in FIGS. 9A to 9C. Coil Lb is formed, for example, between a signal line of a 50Ω type and the ground potential.

As the configuration and the operation are otherwise the same as those of radio reception apparatus 201, detailed description will not be repeated here. According to such a configuration, the reception characteristic of the radio reception apparatus can be improved.

Another embodiment of the present invention will be described hereinafter with reference to the drawings. The same or corresponding elements in the drawings have the same reference characters allotted, and description thereof will not be repeated.

### Second Embodiment

The present embodiment relates to a radio reception apparatus including two output terminals. The configuration and the operation except for those described hereinafter are the same as those in the radio reception apparatus according to the first embodiment.

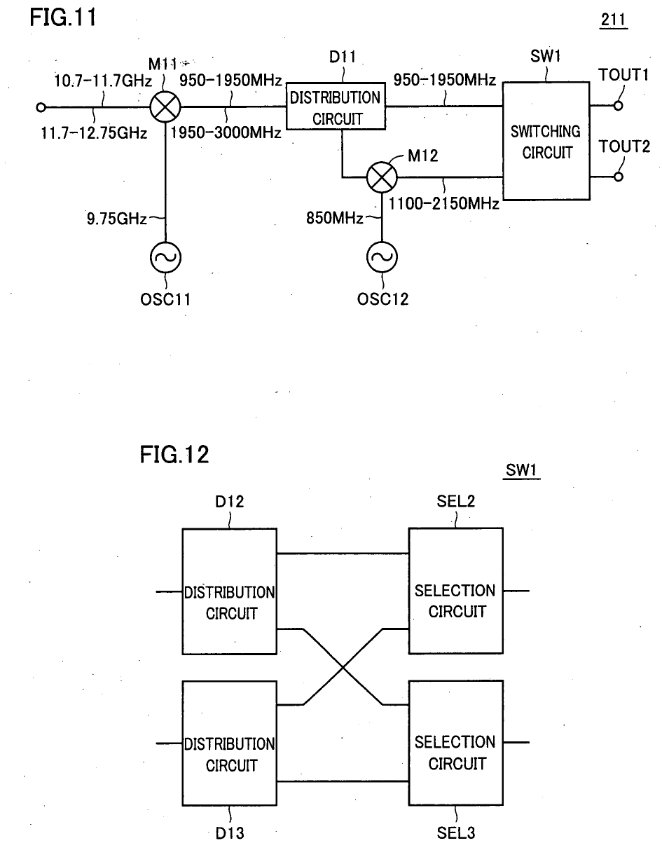

FIG. 11 is a functional block diagram showing a configuration of a radio reception apparatus according to a second embodiment of the present invention.

Referring to FIG. 11, a radio reception apparatus 211 is different from radio reception apparatus 201 according to the first embodiment in further including a switching circuit SW1 and an output terminal TOUT2.

Switching circuit SW1 performs distribution and selection of the first IF signal received from distribution circuit D11 and the second IF signal received from mixer M12, outputs any one of the first IF signal and the second IF signal from output terminal TOUT1 to the outside, and outputs any one of the first IF signal and the second IF signal from output terminal TOUT2 to the outside.

FIG. 12 is a functional block diagram showing a configuration of the switching circuit in the radio reception apparatus according to the second embodiment of the present invention.

Referring to FIG. 12, switching circuit SW1 includes a distribution circuit (a second distribution circuit) D12, a distribution circuit (a third distribution circuit) D13, and selection circuits SEL2 and SEL3.

Distribution circuit D12 distributes the first IF signal received from distribution circuit D11 to selection circuits SEL2 and SEL3. Distribution circuit D13 distributes the second IF signal received from mixer M12 to selection circuits SEL2 and SEL3.

Selection circuit SEL2 selects any one of the first IF signal received from distribution circuit D12 and the second IF signal received from distribution circuit D13, and outputs the selected IF signal from output terminal TOUT1 to the outside. Selection circuit SEL3 selects any one of the first IF signal received from distribution circuit D12 and the second IF signal received from distribution circuit D13, and outputs the selected IF signal from output terminal TOUT2 to the outside.

Therefore, in the radio reception apparatus according to the second embodiment of the present invention, similarly to the radio reception apparatus according to the first embodiment of the present invention, circuits for receiving the RF signals in the number corresponding to the number of RF signals are no longer required, and expensive cost for design and parts can be avoided.

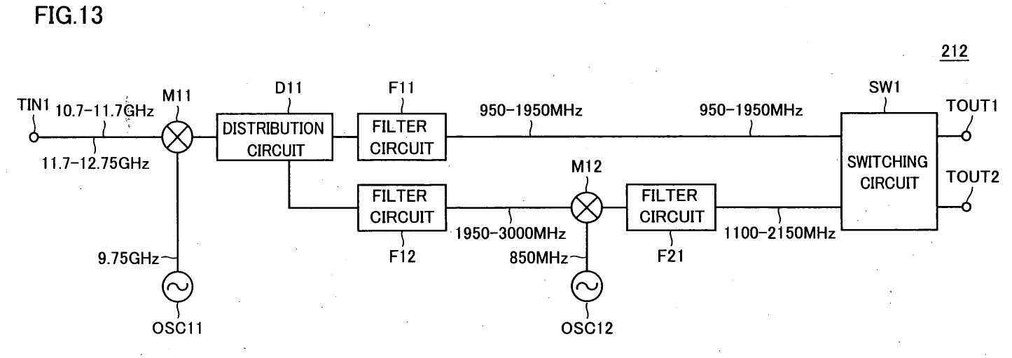

FIG. 13 is a functional block diagram showing a configuration of a radio reception apparatus according to a variation of the second embodiment of the present invention.

Referring to FIG. 13, a radio reception apparatus 212 is different from radio reception apparatus 211 in further including filter circuits F11, F12, and F21.

Distribution circuit D11 distributes the first IF signal received from mixer M11 to filter circuits F11 and F12.

Filter circuits F11 and F12 attenuate the frequency component outside a prescribed frequency band in the first IF signals received from mixer M11.

Mixer M12 multiplies the first IF signal that has passed through filter circuit F12 by the local oscillation signal received from local oscillation circuit OSC12, so as to frequency-convert the first IF signal to the second IF signal.

Filter circuit F21 attenuates the frequency component outside a prescribed frequency band in the second IF signal received from mixer M12.

As the configuration and the operation are otherwise the same as those of radio reception apparatus 211, detailed description will not be repeated here. According to such a configuration, the reception characteristic of the radio reception apparatus can be improved.

Another embodiment of the present invention will be described hereinafter with reference to the drawings. The same or corresponding elements in the drawings have the same reference characters allotted, and description thereof will not be repeated.

### Third Embodiment

The present embodiment relates to a radio reception apparatus including two output terminals and receiving radio signals of two types of polarizations. The configuration and the operation except for those described hereinafter are the same as those in the radio reception apparatus according to the first embodiment.

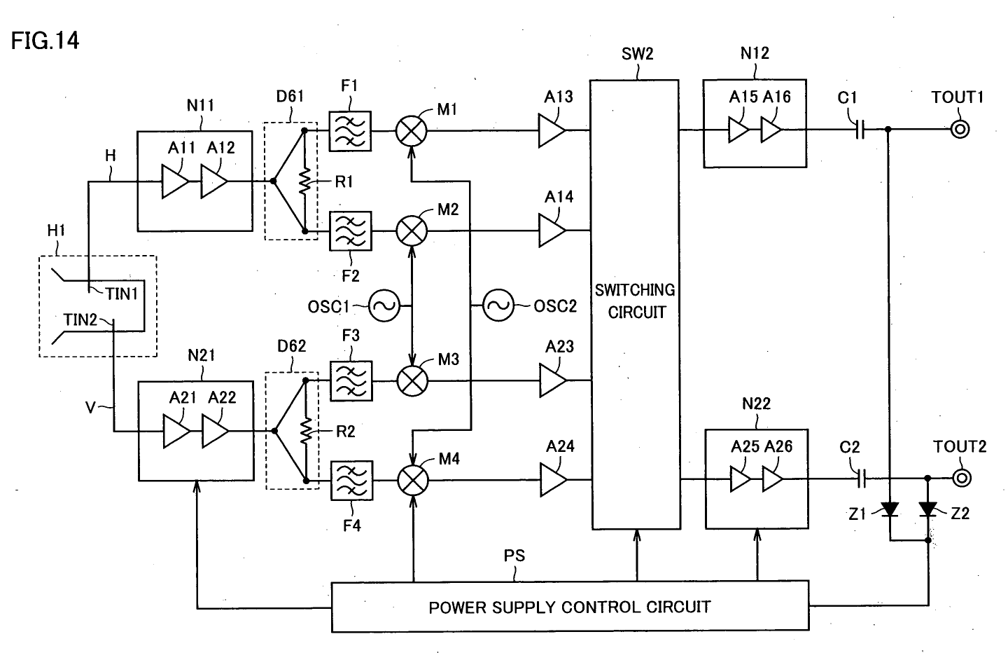

FIG. 14 is a functional block diagram showing an exemplary configuration of a universal twin LNB.

Referring to FIG. 14, the universal twin LNB includes horn portion H1, low-noise amplifier portions N11 and N21, band-pass filters F1 to F4, mixers M1 to M4, local oscillation circuits OSC1 and OSC2, low-noise amplifiers A13, A14, A23, and A24, distribution circuits D61 and D62, a switching circuit SW2, IF amplifier portions N12 and N22, capacitors C1 and C2, diodes Z1 and Z2, output terminals TOUT1 and TOUT2, and power supply control circuit PS. Distribution circuit D61 includes a resistor R1. Distribution circuit D62 includes a resistor R2. Low-noise amplifier portion N11 includes low-noise amplifiers A11 and A12 connected in series. Low-noise amplifier portion N21 includes low-noise amplifiers A21 and A22 connected in series. IF amplifier portion N12 includes low-noise amplifiers A15 and A16 connected in series. IF amplifier portion N22 includes low-noise amplifiers A25 and A26 connected in series.

Horn portion H1 receives the radio signal of H polarization output from broadcast satellite 106 at input terminal TIN1, and outputs the signal to low-noise amplifier N11. In addition, horn portion H1 receives the radio signal of V polarization output from broadcast satellite 106 at input terminal TIN2, and outputs the signal to low-noise amplifier N21.

Low-noise amplifier portion N11 low-noise amplifies the radio signal of H polarization received from horn portion H1 through input terminal TIN1, and outputs the low-noise amplified signal to distribution circuit D61.

Low-noise amplifier portion N21 low-noise amplifies the radio signal of V polarization received from horn portion H1 through input terminal TIN2, and outputs the low-noise amplified signal to distribution circuit D62.

Distribution circuit D61 distributes the signal received from low-noise amplifier portion N11 to band-pass filters F1 and F2.

Distribution circuit D62 distributes the signal received from low-noise amplifier portion N21 to band-pass filters F3 and F4.

Band-pass filters F1 and F2 attenuate the frequency component outside a prescribed frequency band in the signals received from distribution circuit D61.

Band-pass filters F3 and F4 attenuate the frequency component outside a prescribed frequency band in the signals received from distribution circuit D62.

Mixer M1 multiplies the signal that has passed through band-pass filter F1 by the local oscillation signal received from local oscillation circuit OSC2, so as to frequency-convert the signal that has passed through band-pass filter F1 to the IF signal.

Mixer M4 multiplies the signal that has passed through band-pass filter F4 by the local oscillation signal received from local oscillation circuit OSC2, so as to frequency-convert the signal that has passed through band-pass filter F4 to the IF signal.

Mixer M2 multiplies the signal that has passed through band-pass filter F2 by the local oscillation signal received from local oscillation circuit OSC1, so as to frequency-convert the signal that has passed through band-pass filter. F2 to the IF signal.

Mixer M3 multiplies the signal that has passed through band-pass filter F3 by the local oscillation signal received from local oscillation circuit OSC1, so as to frequency-convert the signal that has passed through band-pass filter F3 to the IF signal.

Low-noise amplifiers A13 and A14 as well as A23 and A24 low-noise amplify the IF signals received from mixers M1 to M4 respectively, and output the low-noise amplified signals to switching circuit SW2.

Switching circuit SW2 performs distribution and selection of the signals received from low-noise amplifiers A13 and A14 as well as A23 and A24, and outputs any of the signals received from low-noise amplifiers A13 and A14 as well as A23 and A24 to IF amplifier portions N12 and N22. Namely, switching circuit SW2 includes two 4-input-1-output selection circuits.

IF amplifier portion N12 low-noise amplifies the IF signal received from switching circuit SW2, and outputs the low-noise amplified signal from output terminal TOUT1 to the outside. IF amplifier portion N22 low-noise amplifies the IF signal received from switching circuit SW2, and outputs the low-noise amplified signal from output terminal TOUT2 to the outside.

From output terminals TOUT1 and TOUT2, the IF signal having a frequency band from 950 MHz to 1950 MHz corresponding to the radio signal in low band or the IF signal having a frequency band from 1100 MHz to 2150 MHz corresponding to the radio signal in high band is output.

Capacitor C1 permits passage of only the AC component in the IF signal received from IF amplifier portion N12. Capacitor C2 permits passage of only the AC component in the IF signal received from IF amplifier portion N22.

Electric power is supplied to power supply control circuit PS from an external apparatus such as DBS tuner 104 through output terminals TOUT1 and TOUT2.

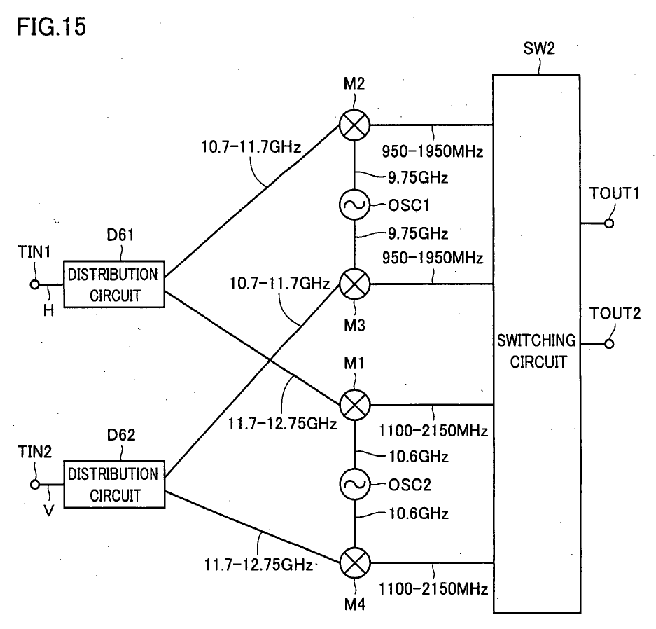

FIG. 15 is a functional block diagram showing an exemplary configuration of the universal twin LNB.

Referring to FIG. 15, the universal twin LNB includes input terminals (reception portions) TIN1 and TIN2, mixers M1 to M4, distribution circuits D61 and D62, local oscillation circuits OSC1 and OSC2, switching circuit SW2, and output terminals TOUT1 and TOUT2.

Distribution circuit D61 distributes the radio signal of H polarization received at input terminal TIN1 to mixer M1 and mixer M2. Distribution circuit D62 distributes the radio signal of V polarization received at input terminal TIN2 to mixer M3 and mixer M4.

Mixer M1 multiplies the radio signal of H polarization received from distribution circuit D61 by the local oscillation signal received from local oscillation circuit OSC2, so as to frequency-convert the radio signal of H polarization to the IF signal. For example, if the universal twin LNB receives the radio signal of H polarization in high band, the IF signal output from mixer M2 has a frequency band from 1100 MHz to 2150 MHz. Similarly, mixer M4 multiplies the radio signal of V polarization received from distribution circuit D62 by the local oscillation signal received from local oscillation circuit OSC2, so as to frequency-convert the radio signal of V polarization to the IF signal.

Mixer M2 multiplies the radio signal of H polarization received from distribution circuit D61 by the local oscillation signal received from local oscillation circuit OSC1, so as to frequency-convert the radio signal of H polarization to the IF signal. For example, if the universal twin LNB receives the radio signal of H polarization in low band, the IF signal output from mixer M2 has a frequency band from 950 MHz to 1950 MHz. Similarly, mixer M3 multiplies the radio signal of V polarization received from distribution circuit D62 by the local oscillation signal received from local oscillation circuit OSC1, so as to frequency-convert the radio signal of V polarization to the IF signal.

Switching circuit SW2 performs distribution and selection of the IF signals received from mixers M1 to M4, outputs any one of the IF signals received from mixers M1 to M4 from output terminal TOUT1 to the outside, and outputs any one of the IF signals received from mixers M1 to M4 from output terminal TOUT2 to the outside.

For example, if the universal twin LNB receives the radio signal of H polarization in high band, switching circuit SW2 selects an IF signal received from mixer M1 and having a frequency band from 1100 MHz to 2150 MHz and outputs the selected signal. In addition, if the universal twin LNB receives the radio signal of H polarization in low band, switching circuit SW2 selects an IF signal received from mixer M2 and having a frequency band from 950 MHz to 1950 MHz and outputs the selected signal. If the universal twin LNB receives the radio signal of V polarization in low band, switching circuit SW2 selects the IF signal received from mixer M3 and having a frequency band from 950 MHz to 1950 MHz and outputs the selected signal. In addition, if the universal twin LNB receives the radio signal of V polarization in high band, switching circuit SW2 selects the IF signal received from mixer M4 and having a frequency band from 1100 MHz to 2150 MHz and outputs the selected signal.

As the configuration and the operation are otherwise the same as in the universal twin LNB shown in FIG. 14, detailed description will not be repeated here.

Here, the universal twin LNBs shown in FIGS. 14 and 15 should include four RF circuits constituted of mixers, local oscillation circuits, and the like, in correspondence with the radio signals of H polarization and V polarization and in high band and low band, and cost for design and parts of the radio reception apparatus become expensive.

The radio reception apparatus according to the third embodiment of the present invention solves such a problem of the universal twin LNBs shown in FIGS. 14 and 15.

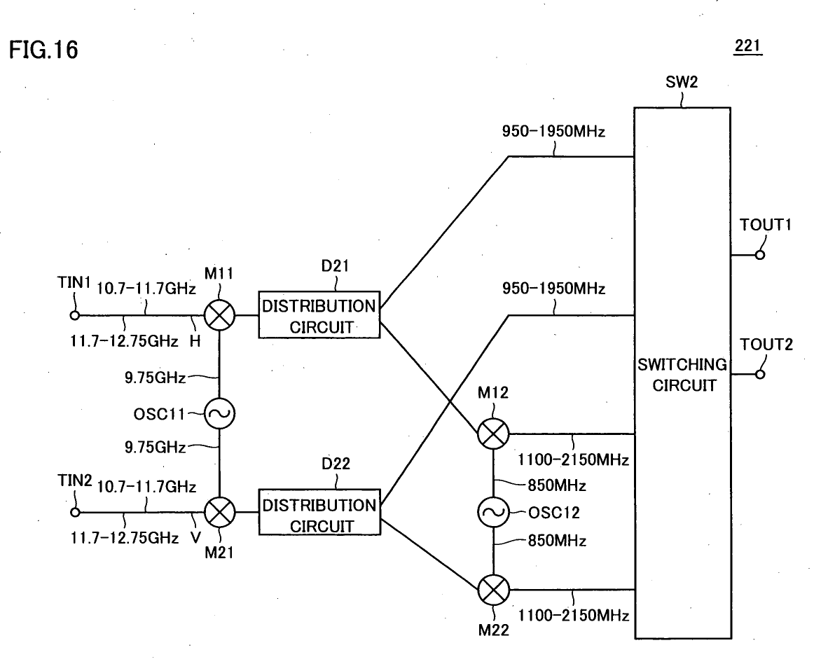

FIG. 16 is a functional block diagram showing a configuration of the radio reception apparatus according to the third embodiment of the present invention.

Referring to FIG. 16, a radio reception apparatus 221 includes input terminals (reception portions) TIN1 and TIN2, mixers (RF mixers) M11 and M21, mixers (IF mixers) M12 and M22, distribution circuits (first distribution circuits) D21 and D22, local oscillation circuits OSC11 and OSC12, switching circuit SW2, and output terminals TOUT1 and TOUT2.

Local oscillation circuit OSC11 outputs a local oscillation signal, for example, at a frequency of 9.75 GHz. Local oscillation circuit OSC12 outputs a local oscillation signal, for example, at a frequency of 850 MHz.

Mixer M11 multiplies the radio signal of H polarization received at input terminal TIN1 by the local oscillation signal received from local oscillation circuit OSC11, so as to frequency-convert the radio signal of H polarization to the first IF signal. Mixer M21 multiplies the radio signal of V polarization received at input terminal TIN2 by the local oscillation signal received from local oscillation circuit OSC11, so as to frequency-convert the radio signal of V polarization to the first IF signal. For example, if radio reception apparatus 221 receives the radio signal in low band, the first IF signal has a frequency band from 950 GHz to 1950 MHz. In addition, if radio reception apparatus 221 receives the radio signal in high band, the first IF signal has a frequency band from 1950 MHz to 3000 MHz.

Distribution circuit D21 distributes the first IF signal received from mixer M11 to switching circuit SW2 and mixer M12. Distribution circuit D22 distributes the first IF signal received from mixer M21 to switching circuit SW2 and mixer M22.

Mixer M12 multiplies the first IF signal received from distribution circuit D21 by the local oscillation signal received from local oscillation circuit OSC12, so as to frequency-convert the first IF signal to the second IF signal. Mixer M22 multiplies the first IF signal received from distribution circuit D22 by the local oscillation signal received from local oscillation circuit OSC12, so as to frequency-convert the first IF signal to the second IF signal. For example, if radio reception apparatus 221 receives the radio signal in high band, the second IF signal has a frequency band from 1100 MHz to 2150 MHz.

Switching circuit SW2 performs distribution and selection of the IF signals received from distribution circuits D21 and D22 and mixers M11 and M22, outputs any one of the IF signals received from distribution circuits D21 and D22 and mixers M11 and M22 from output terminal TOUT1 to the outside, and outputs any one of the IF signals received from distribution circuits D21 and D22 and mixers M11 and M22 from output terminal TOUT2 to the outside.

For example, if radio reception apparatus 221 receives the radio signal of H polarization in low band, switching circuit SW2 selects the IF signal received from distribution circuit D21 and having a frequency band from 950 MHz to 1950 MHz and outputs the selected signal. In addition, if radio reception apparatus 221 receives the radio signal of V polarization in low band, switching circuit SW2 selects the IF signal received from distribution circuit D22 and having a frequency band from 950 MHz to 1950 MHz and outputs the selected signal. If radio reception apparatus 221 receives the radio signal of H polarization in high band, switching circuit SW2 selects the IF signal received from mixer M12 and having a frequency band from 1100 MHz to 2150 MHz and outputs the selected signal. In addition, if radio reception apparatus 221 receives the radio signal of V polarization in high band, switching circuit SW2 selects the IF signal received from mixer M22 and having a frequency band from 1100 MHz to 2150 MHz and outputs the selected signal.

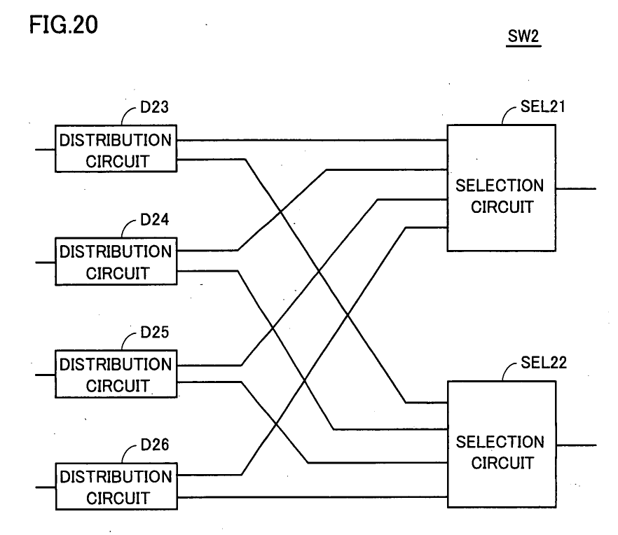

FIG. 20 is a functional block diagram showing a configuration of the switching circuit in the radio reception apparatus according to the third embodiment of the present invention.

Referring to FIG. 20, switching circuit SW2 includes distribution circuits (fourth distribution circuits) D23 to D26 and selection circuits SEL21 and SEL22.

Distribution circuit D23 distributes the first IF signal received from distribution circuit D21 to selection circuits SEL21 and SEL22. Distribution circuit D24 distributes the first IF signal received from distribution circuit D22 to selection circuits SEL21 and SEL22. Distribution circuit D25 distributes the second IF signal received from mixer M12 to selection circuits SEL21 and SEL22. Distribution circuit D26 distributes the second IF signal received from mixer M22 to selection circuits SEL21 and SEL22.

Selection circuit SEL21 selects any one of the IF signals received from distribution circuits D23 to D26, and outputs the selected IF signal from output terminal TOUT1 to the outside. Selection circuit SEL22 selects any one of the IF signals received from distribution circuits D23 to D26, and outputs the selected IF signal from output terminal TOUT2 to the outside.

As the configuration and the operation are otherwise the same as in the universal twin LNB shown in FIG. 15, detailed description will not be repeated here.

Therefore, in the radio reception apparatus according to the third embodiment of the present invention, similarly to the radio reception apparatus according to the first embodiment of the present invention, circuits for receiving the RF signals in the number corresponding to the number of RF signals are no longer required, and expensive cost for design and parts can be avoided.

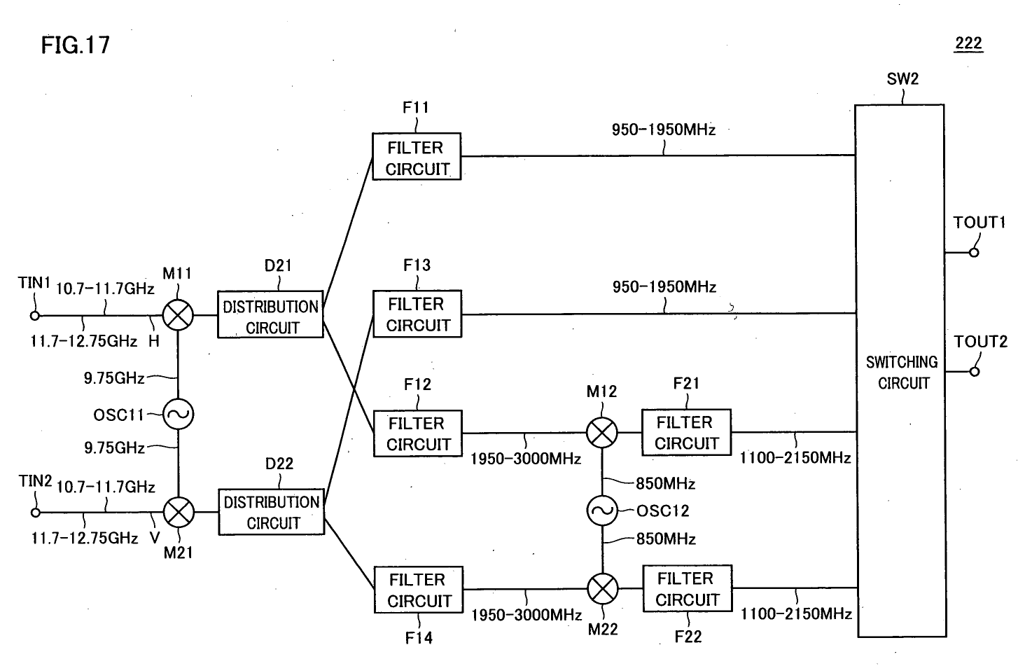

FIG. 17 is a functional block diagram showing a configuration of a radio reception apparatus according to a variation of the third embodiment of the present invention.

Referring to FIG. 17, a radio reception apparatus 222 is different from radio reception apparatus 221 in further including filter circuits F11 to F14 and F21 to F22.

Distribution circuit D21 distributes the first IF signal received from mixer M11 to filter circuits F11 and F12. Distribution circuit D22 distributes the first IF signal received from mixer M21 to filter circuits F13 and F14.

Filter circuits F11 and F12 attenuate the frequency component outside a prescribed frequency band in the first IF signals received from mixer M11. Filter circuits F13 and F14 attenuate the frequency component outside a prescribed frequency band in the first IF signals received from mixer M21.

Mixer M12 multiplies the first IF signal that has passed through filter circuit F12 by the local oscillation signal received from local oscillation circuit OSC12, so as to frequency-convert the first IF signal to the second IF signal. Mixer M22 multiplies the first IF signal that has passed through filter circuit F14 by the local oscillation signal received from local oscillation circuit OSC12, so as to frequency-convert the first IF signal to the second IF signal.

Filter circuit F21 attenuates the frequency component outside a prescribed frequency band in the second IF signal received from mixer M12. Filter circuit F22 attenuates the frequency component outside a prescribed frequency band in the second IF signal received from mixer M22.

As the configuration and the operation are otherwise the same as those of radio reception apparatus 221, detailed description will not be repeated here. According to such a configuration, the reception characteristic of the radio reception apparatus can be improved.

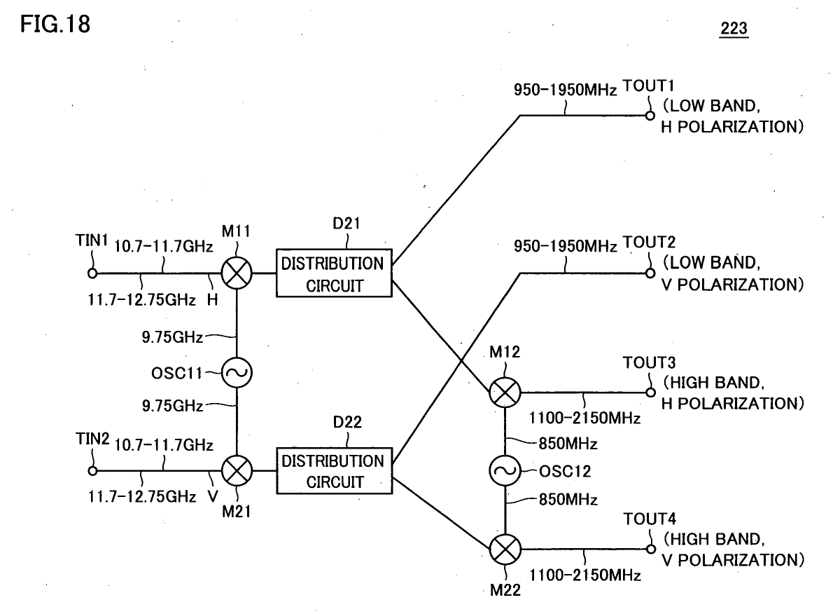

FIG. 18 is a functional block diagram showing a configuration of a radio reception apparatus according to a variation of the third embodiment of the present invention.

Referring to FIG. 18, a radio reception apparatus 223 is different from radio reception apparatus 221 in further including output terminals TOUT3 and TOUT4 but not including switching circuit SW2.

If radio reception apparatus 223 receives the radio signal of H polarization in low band, an IF signal having a frequency band from 950 MHz to 1950 MHz corresponding to low band is output from output terminal TOUT1 to the outside. In addition, if radio reception apparatus 223 receives the radio signal of V polarization in low band, an IF signal having a frequency band from 950 MHz to 1950 MHz corresponding to low band is output from output terminal TOUT2 to the outside. If radio reception apparatus 223 receives the radio signal of H polarization in high band, an IF signal having a frequency band from 1100 MHz to 2150 MHz corresponding to high band is output from output terminal TOUT3 to the outside. In addition, if radio reception apparatus 223 receives the radio signal of V polarization in high band, an IF signal having a frequency band from 1100 MHz to 2150 MHz corresponding to high band is output from output terminal TOUT4 to the outside.

As the configuration and the operation are otherwise the same as those of radio reception apparatus 221, detailed description will not be repeated here.

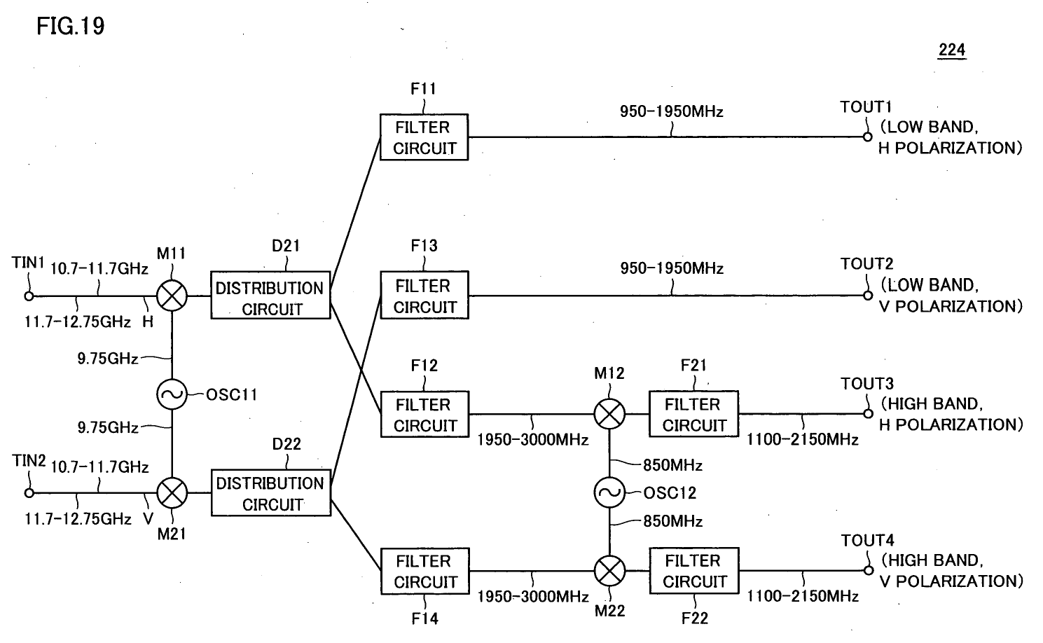

FIG. 19 is a functional block diagram showing a configuration of a radio reception apparatus according to a variation of the third embodiment of the present invention.

Referring to FIG. 19, a radio reception apparatus 224 is different from radio reception apparatus 222 in further including output terminals TOUT3 and TOUT4 but not including switching circuit SW2.

As the configuration and the operation are otherwise the same as those of radio reception apparatus 222, detailed description will not be repeated here. According to such a configuration, the reception characteristic of the radio reception apparatus can be improved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A radio reception apparatus comprising:
a reception portion receiving a radio signal;
a first local oscillation circuit outputting a first local oscillation signal;
a second local oscillation circuit outputting a second local oscillation signal;
an RF mixer frequency-converting the received radio signal by multiplying said received radio signal by said first local oscillation signal and outputting the frequency-converted signal;
a first distribution circuit distributing the output signal of said RF mixer; and
an IF mixer frequency-converting said output signal of said RF mixer by multiplying any one of the signals distributed by said first distribution circuit by said second local oscillation signal and outputting the frequency-converted signal.

2. The radio reception apparatus according to claim 1, further comprising a selection circuit selecting any one of the signals distributed by said first distribution circuit and the output signal of said IF mixer and outputting the selected signal.

3. The radio reception apparatus according to claim 1, further comprising:
a second distribution circuit distributing the signal distributed by said first distribution circuit;
a third distribution circuit distributing the output signal of said IF mixer; and
a plurality of selection circuits each receiving the signal distributed by said second distribution circuit and the signal distributed by said third distribution circuit, selecting any one of the received distributed signals, and outputting the selected signal.

4. The radio reception apparatus according to claim 1, further comprising:
a first filter circuit attenuating a prescribed frequency component contained in said signal distributed by said first distribution circuit; and
a second filter circuit attenuating a prescribed frequency component contained in the output signal of said IF mixer.

5. The radio reception apparatus according to claim 4, wherein
said first filter circuit and said second filter circuit are formed with an element or a pattern.

6. The radio reception apparatus according to claim 1, receiving a plurality of radio signals different in polarization and comprising a plurality of said reception portions, a plurality of said RF mixers, a plurality of said first distribution circuits, and a plurality of said IF mixers, in correspondence with said radio signals.

7. The radio reception apparatus according to claim 6, further comprising a selection circuit selecting any one of the signals distributed by said plurality of first distribution circuits and the output signals of said plurality of IF mixers, and outputting the selected signal.
